(19) United States
(12) Patent Application Publication
(10) Pub. No.: US 2026/0135609 A1
(43) Pub. Date: May 14, 2026

(54) METHODS AND APPARATUSES FOR PHYSICAL UPLINK CONTROL CHANNEL TRANSMISSION IN CASE OF BEAM FAILURE

(71) Applicant: Lenovo (Beijing) Limited, Beijing (CN)

(72) Inventors: Bingchao Liu, Beijing (CN); Chenxi Zhu, Beijing (CN); Lianhai Wu, Beijing (CN)

(73) Assignee: Lenovo (Beijing) Limited, Beijing (CN)

(21) Appl. No.: 18/683,329

(22) PCT Filed: Aug. 13, 2021
(86) PCT No.: PCT/CN2021/112486

§ 371 Date: Feb. 13, 2024

(51) Int. Cl. H04B 7/06; H04W 72/1268

(52) U.S. Cl. CPC H04B 7/06964; H04W 72/1268

(57) ABSTRACT

Disclosed are methods and apparatuses for physical uplink control channel (PUCCH) transmission. An embodiment of the subject application provides a method performed by a user equipment. The method includes: receiving a configuration of two physical uplink control channel scheduling request (PUCCH-SR) resources for beam failure recovery request (BFRQ) transmission for a cell group when two beam failure detection reference signal (BFD-RS) sets and two new beam indication reference signal (NBI-RS) sets are configured for a cell of the cell group, wherein there is one-to-one association between the two PUCCH-SR resources and the two BFD-RS sets, and there is one-to-one association between the two BFD-RS sets and the two NBI-RS sets, in response to that only one of the two BFD-RS sets is failed, transmitting a BFRQ in one PUCCH-SR resource of the two PUCCH-SR resources according to an association between the two PUCCH-SR resources and the two BFD-RS sets, and in response to that the two BFD-RS sets are failed, initiating a random access (RA) procedure to transmit a BFRQ, wherein the cell is a primary cell (PCell) or a primary secondary cell (PSCell).

### TECHNICAL FIELD

The present disclosure generally relates to wireless communication technologies, and especially to methods and apparatuses for physical uplink control channel (PUCCH) transmission for beam failure recovery (BFR).

### BACKGROUND OF THE INVENTION

There is requirement on enhancement on support for multi-transmit receive point (TRP) deployment, where a user equipment (UE) is served by more than one TRPs in a serving cell, targeting both frequency range (FR) 1 (which indicates a frequency range 410 MHz˜7125 MHz), and FR2 (which indicates a frequency range 24250 MHz˜52.6 GHz).

TRP-specific BFR is designed for a wireless network. Two beam failure detection (BFD) reference signal (RS) sets may be configured supporting multi-TRP function in a cell, where each BFD-RS set is associated with one TRP in case two TRPs are configured in a cell. Besides, two new beam indicator (NBI) RS sets may be configured, where there is one to one association between each BFD-RS set of the two BFD-RS sets and each NBI-RS set of the two NBI-RS sets.

A set of periodic reference signals (RSs), e.g. none-zero-power (NZP) channel state information-reference signal (CSI-RS) resources and/or synchronization signal (SS) and/or physical broadcast channel (PBCH) block (SSB) resources, are configured for a UE for beam failure detection (BFD). Once a UE detects a beam failure (i.e., qualities of all configured RSs for BFD are lower than a configured threshold) on a secondary cell, the UE may send a beam failure recovery request (BFRQ) by using a dedicated PUCCH scheduling request (PUCCH-SR) to a base station (BS). Single downlink control information (single-DCI) based and multi-DCI based multiple TRP download link (DL) transmission are specified in Rel-16 on SpCell (general term for primary cell (PCell) and primary secondary cell group Cell (PSCell)) as well as secondary Cell (SCell). The UE is required to maintain two different TRP-UE links in a serving cell.

### SUMMARY

Up to two PUCCH-SR resources can be configured for a cell group for the UE to send BFRQ transmission. Embodiments of the present disclosure provide solutions related to PUCCH-SR transmission for BFR procedure, which may address issues including, for example and not limited to, when to configure two PUCCH-SR resources, how to select PUCCH-SR resource(s) for BFRQ transmission, and how to update beam(s) for PUCCH and PDCCH after BFR.

According to some embodiments of the present disclosure, a method performed by a UE is provided. The method includes: receiving a configuration of two PUCCH-SR resources for BFRQ transmission for a cell group when two beam failure detection reference signal (BFD-RS) sets and two new beam indication reference signal (NBI-RS) sets are configured for a cell of the cell group, wherein there is one-to-one association between the two PUCCH-SR resources and the two BFD-RS sets, and there is one-to-one association between the two BFD-RS sets and the two NBI-RS sets, in response to that only one of the two BFD-RS sets is failed, transmitting a BFRQ in one PUCCH-SR resource of the two PUCCH-SR resources according to an association between the two PUCCH-SR resources and the two BFD-RS sets, and in response to that the two BFD-RS sets are failed, initiating a random access (RA) procedure to transmit a BFRQ, wherein the cell is a PCell in a master cell group (MCG) or a PSCell in a secondary cell group (SCG).

In some embodiments, an index of the one PUCCH-SR resource is associated with an index of one of the two BFD-RS sets which is not failed.

In some embodiments, an index of the one PUCCH-SR resource is associated with an index of one of the two BFD-RS sets which is failed.

In some embodiments, in response to that only one BFD-RS set of the two BFD-RS sets is failed, the method further includes receiving a first physical downlink control channel (PDCCH) with a downlink control information (DCI) format for scheduling a first physical uplink shared channel (PUSCH) resource, transmitting a medium access control (MAC) control element (CE) in the first PUSCH resource to indicate an index of the failed BFD-RS set and information of a new beam found in a NBI-RS set associated with the failed BFD-RS set.

In some embodiments, in response to that the two BFD-RS sets are both failed, the RA procedure is a contention-free random access procedure when one or more CF-RACH resources are configured for the cell and a new beam associated with one CF-RACH resource is found.

In some embodiments, in response to that the new beam is found, the method further includes: detecting a DCI format with cyclic redundancy check (CRC) scrambled by cell-radio network temporary identifier (C-RNTI) or modulation coding scheme C-RNTI (MCS-C-RNTI) in a dedicated search space for BFR procedure, and transmitting an MAC CE in a first PUSCH resource scheduled by the DCI format to indicate indices of the two failed BFD-RS sets and information of new beams identified in the two NBI-RS sets associated with the failed BFD-RS sets.

In some embodiments, in response to that the two BFD-RS sets are both failed, the RA procedure is a contention-based RACH (CB-RACH) procedure when no CF-RACH resource is configured or one or more CF-RACH resources are configured while no new beam associated with the CF-RACH resources is found.

In some embodiments, in response to that two new beams are found in the two NBI-RS sets associated with the two failed BFD-RS sets, the method further includes transmitting an MAC CE in a first PUSCH resource via Msg3 or MsgA to indicate the indices of the two failed BFD-RS sets and information of the two new beams identified in the two NBI-RS sets.

In some embodiments, the method further includes receiving a second PDCCH with a DCI format for scheduling a second PUSCH resource, wherein the DCI format indicates a same hybrid automatic repeat request (HARQ) process number as that for transmission of the first PUSCH resource and has a toggled new data indication (NDI) field value.

In some embodiments, after a pre-defined number of symbols from reception of a last symbol of the second PDCCH, the method further includes: monitoring PDCCH(s) in all control resource sets (CORESETs) associated with at last one failed BFD-RS set by using antenna port quasi co-location parameters corresponding to at least one new beam identified in at least one NBI-RS set associated with at least one failed BFD-RS set, and updating at least one spatial relation and at least one PL-RS for PUCCH resources associated with the at least one failed BFD-RS set according to the at least one new beam identified in the at least one NBI-RS set associated with the at least one failed BFD-RS set.

According to some embodiments of the present disclosure, a method performed by a BS is provided. The method includes: transmitting a configuration of two PUCCH-SR resources for BFRQ transmission for a cell group when two BFD-RS sets and two NBI-RS sets are configured for a cell of the cell group, wherein there is one-to-one association between the two PUCCH-SR resources and the two BFD-RS sets, and there is one-to-one association between the two BFD-RS sets and the two NBI-RS sets, and receiving a BFRQ in one of the two PUCCH-SR resources according to an association between the two PUCCH-SR resources and the two BFD-RS sets, or receiving a BFRQ during an RA procedure, wherein the cell is a PCell in a MCG or a PSCell in a SCG.

In some embodiments, if the BFRQ is received in the one PUCCH-SR resource, an index of the one PUCCH-SR resource is associated with an index one of the two BFD-RS sets which is not failed.

In some embodiments, if the BFRQ is received in the one PUCCH-SR resource, an index of the one PUCCH-SR resource is associated with an index of one of the two BD-RS sets which is failed.

In some embodiments, in response to that the BFRQ is received in the one PUCCH-SR resource, the method further includes: transmitting a first PDCCH with a DCI format for scheduling a first PUSCH resource, and receiving an MAC CE in the first PUSCH resource to indicate an index of the failed BFD-RS set and information of a new beam found in a NBI-RS set associated with the failed BFD-RS set.

In some embodiments, the BFRQ is received during a CF-RACH procedure.

In some embodiments, the method further includes: transmitting a DCI format with cyclic redundancy check (CRC) scrambled by C-RNTI or MCS-C-RNTI in a dedicated search space for BFR procedure, and receiving an MAC CE in a first PUSCH resource scheduled by the DCI format to indicate indices of the two failed BFD-RS sets and information of new beams identified in the two NBI-RS sets associated with the failed BFD-RS sets.

In some embodiments, the BFRQ is received during a CB-RACH procedure.

In some embodiments, the method further includes receiving an MAC CE in a first PUSCH resource via Msg3 or MsgA to indicate the two failed BFD-RS set and information of two new beams found in the two NBI-RS sets associated with the two failed BFD-RS sets.

In some embodiments, the method further includes transmitting a second PDCCH with a DCI format for scheduling a second PUSCH resource, wherein the DCI format indicates a same HARQ process number as that for transmission of the first PUSCH resource and has a toggled new data indication (NDI) field value.

In some embodiments, after a pre-defined number of symbols from transmission of a last symbol of the second PDCCH, the method further includes:
transmitting PDCCH(s) in all CORESETs associated with at last one failed BFD-RS set by using antenna port quasi co-location parameters corresponding to at least one new beam indicated in the MAC CE, and updating at least one spatial relation and at least one PL-RS for receiving PUCCH resources associated with the at least one failed BFD-RS set according to the at least one new beam indicated in the MAC CE.

According to some embodiments of the present disclosure, an apparatus includes: a non-transitory computer-readable medium having stored thereon computer-executable instructions, a receiving circuitry, a transmitting circuitry, and a processor coupled to the non-transitory computer-readable medium, the receiving circuitry and the transmitting circuitry, wherein the computer-executable instructions, when executed by the processor, cause the apparatus to implement various methods according to any embodiments of the present disclosure.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates a schematic diagram of an exemplary wireless communication system according to some embodiments of the present disclosure;

FIG. 2, including 2(a) and 2(b), illustrates exemplary BFD-RS sets configurations according to some embodiments of the present disclosure;

FIG. 3 illustrates a flow chart of an exemplary method performed by a UE according to some embodiments of the present disclosure;

FIG. 4 illustrates a flow chart of an exemplary method performed by a BS according to some embodiments of the present disclosure;

FIG. 5 illustrates a signaling flow chart according to some embodiments of the present disclosure;

FIG. 6 illustrates a signaling flow chart according to some embodiments of the present disclosure;

FIG. 7 illustrates a signaling flow chart according to some embodiments of the present disclosure;

FIG. 8 illustrates a simplified block diagram of an exemplary apparatus according to some embodiments of the present disclosure; and

FIG. 9 illustrates a simplified block diagram of an exemplary apparatus according to some other embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3^{rd} generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

In some embodiments of the present disclosure, a BS may be referred to as an access point, an access terminal, a base, a base unit, a macro cell, a Node-B, an enhanced Node-B, an evolved Node B (eNB), a gNB, a Home Node-B, a relay node, or a device, or described using other terminology used in the art. The BS is generally part of a radio access network that may include a controller communicably coupled to the BS. According to the present disclosure, the BS may be configured with multiple TRPs (or panels), wherein a TRP can act like a small BS and is used to serve one or more UEs under control of a BS. In different scenarios, the TRP may be referred to as different terms. Persons skilled in the art should understand that as the 3GPP and the communication technology develop, the terminologies recited in the specification may change, which should not affect the scope of the present disclosure. It should be understood that the TRP(s) (or panel(s)) configured for the BS may be transparent to a UE.

In some embodiments of the present disclosure, a UE may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

FIG. 1 illustrates a schematic diagram of an exemplary wireless communication system according to some embodiments of the present disclosure.

As shown in FIG. 1, there are two cell groups, one is a master cell group (MSG) and the other is a secondary cell group (SCG), wherein the MSG and the SCG are in dual connectivity (DC). In the MSG, there is a PCell and multiple SCell, they are united through carrier aggregation (CA) technology. In the SSG, there is a PSCell and multiple SCell, and they are united through CA technology as well. Herein, a PCell and a PSCell are collectively referred to as special Cells (SpCells). Each of the secondary cells in MCG and in SCG is called SCell. A serving cell refers to a PCell or a PSCell or a SCell.

Although in FIG. 1, for each of the MSG or SCG, there are two SCells are illustrates, it should be appreciated that there may be more than two SCells in a MSG or a SCG; some of them are not shown in FIG. 1 for simplification.

According to the present disclosure, for a cell group (MSG or SCG), multi-TRPs are supported in one or more serving cells, and in each cell, up to two TRPs are supported, up to two BFD-RS sets may be supported, and each BFD-RS set is associated with one TRP. For each BFD-RS set, there is an associated NBI-RS set.

According to the present disclosure, PUCCH can only be transmitted on a PCell or a PSCell. One or more dedicated PUCCH resource, e.g., PUCCH-SR, is configured on the PCell or PSCell for BFRQ transmission. If a UE detects a beam failure in a serving cell (PCell, PSCell, or SCell), it may send a BFRQ via a PUCCH-SR resource on a PCell or a PSCell. Herein, a failure of a BFD-RS set or a beam failure may mean that the radio link quality of all RSs in a BFD-RS set is worse than a configured threshold.

For a cell group supporting multi-TRPs, which means that multi-DCI based multi-TRP functionality can be configured in one or more serving cells in the cell group, a SpCell of the cell group may support be configured with two TRPs. In multi-DCI based multi-TRP operation, multiple TRPs (e.g., two TRPs) are configured in a serving cell, and each TRP can sent a DCI scheduling a PDSCH transmission transmitted from the TRP to the UE. The UE is required to maintain more than one different TRP-UE radio links in a serving cell. In this case, two BFD-RS sets and two PUCCH-SR resources may be configured, each BFD-RS set is associated with a TRP, and each PUCCH-SR resource is associated with a BFD-RS set.

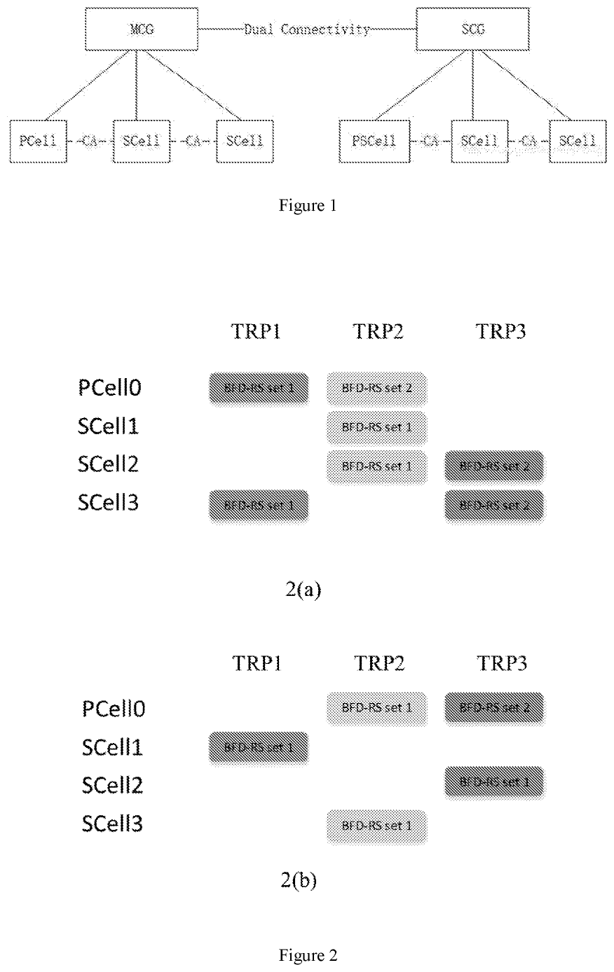

FIG. 2 illustrates two exemplary BFD-RS set and PUCCH-SR resource configurations for a MCG in multi-TRP scenario according to some embodiments of the present disclosure; wherein the MCG includes PCell0, SCell1, SCell2 and SCell3. It is appreciated that these examples are suitable for a SCG as well, wherein PCell0 is taken place with PSCell0.

In FIG. 2(a), two BFD-RS sets are configured for PCell0, BFD-RS set 1 is associated with TRP1, and BFD-RS set 2 is associated with TRP2. In the example shown in FIG. 2(a), two PUCCH-SR resources can be configured for the MCG.

In FIG. 2(b), two BFD-RS sets are configured for PCell0, BFD-RS set 1 is associated with TRP2, and BFD-RS set 2 is associated with TRP3. In the example shown in FIG. 2(b), two PUCCH-SR resources can be configured for the MCG.

If a serving cell of a UE is a SpCell (e.g., PCell0), and the UE detects that only one BFD-RS set fails (i.e., a beam failure occurs on an associated TRP), it may transmit a BFRQ via a PUCCH-SR resource associated with the non-failed TRP.

If a serving cell of a UE is a SCell (i.e., SCell 1), and the UE detects that only one BFD-RS set fails, it may transmit a BFRQ via any one of the two PUCCH-SR resources. In some embodiments, the UE may even transmit a BFRQ in each PUCCH-SR resource.

When the UE detects a BFD-RS set fails, it may look for a new beam from a NBI-RS set associated with the BFD-RS set, wherein the NBI-RS set consists of multiple periodic DL RSs for new beam identification when the associated BFD-RS set fails. A new beam found means that the radio link quality of at least one RS in the NBI RS set is equal to or larger than another configured threshold.

If the UE find a new beam in a NBI RS set associated with a failed BFD-RS set, the UE further transmits an MAC CE indicating an index of the failed BFD-RS set and information of the new beam.

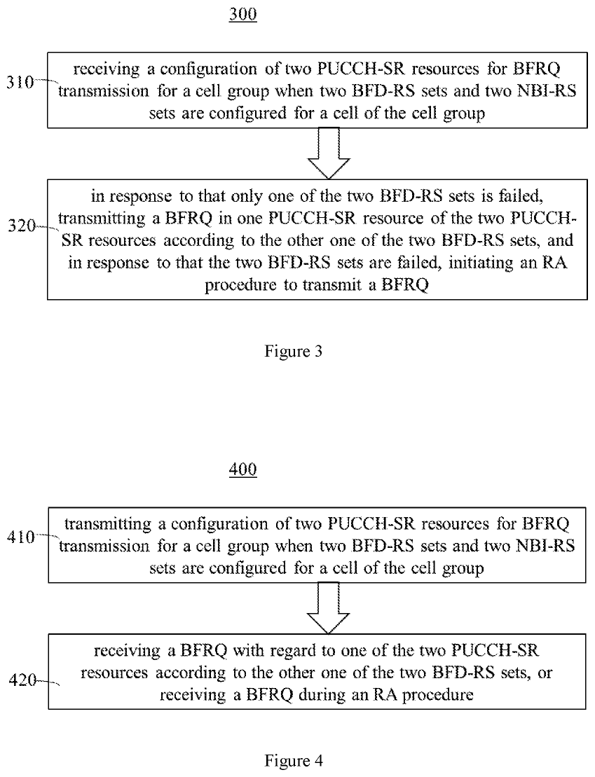

FIG. 3 illustrates a flow chart of an exemplary method 300 performed by a UE according to some embodiments of the present disclosure. It should be understood that method 300 can also be performed by other device(s) having similar functionality. As shown in FIG. 3, method 300 includes at least operation 310 and operation 320.

Operation 310 illustrates that a UE receives a configuration of two PUCCH-SR resources for BFRQ transmission for a cell group when two BFD-RS sets and two new NBI-RS sets are configured for a cell of the cell group, wherein there is one-to-one association between the two PUCCH-SR resources and the two BFD-RS sets, and there is one-to-one association between the two BFD-RS sets and the two NBI-RS sets, wherein the cell is a PCell or a PSCell (i.e., the cell is a SpCell).

Operation 320 illustrates that, if only one of the two BFD-RS sets fails, the UE transmits a BFRQ in one PUCCH-SR resource of the two PUCCH-SR resources according to the other one of the two BFD-RS sets.

Operation 320 also illustrates that, if the two BFD-RS sets fail, the UE initiates an RA procedure to transmit a BFRQ. When both the two BFD-RS sets in the PCell or PSCell fail, it means that the BFRQ cannot be sent to any TRP even if the UE successfully find new beams in the two NBI-RS sets associated with the two BFD-RS sets. Therefore, the UE has to initiate an RA procedure for BFRQ transmission.

FIG. 4 illustrates a flow chart of an exemplary method 400 performed by a BS according to some embodiments of the present disclosure. It should be understood that method 400 can also be performed by other device(s) having similar functionality. As shown in FIG. 4, method 400 includes at least operation 410 and operation 420.

Operation 410 illustrates that a BS transmits a configuration of two PUCCH-SR resources for BFRQ transmission for a cell group when two BFD-RS sets and two NBI-RS sets are configured for a cell of the cell group, wherein there is one-to-one association between the two PUCCH-SR resources and the two BFD-RS sets, and there is one-to-one association between the two BFD-RS sets and the two NBI-RS sets, herein the cell is a PCell or a PSCell, i.e., the cell is a SpCell.

Operation 420 illustrates that, in some embodiments, the BS receives a BFRQ in one of the two PUCCH-SR resources according to one of the two BFD-RS sets; this is in the case that the UE detects only one beam failure on a BFD-RS set and a new beam is found from an associated NBI-RS set.

Operation 420 also illustrates that, in some embodiments, the BFRQ is received in an RA procedure; this is in the case that the UE transmitting the BFRQ detects both two BFD-RS sets fail in the serving cell.

For a SpCell configured with two PUCCH-SR resources, when only one of the BFD-RS set fails, the UE needs to select one PUCCH-SR resource for BFRQ transmission.

In some embodiments, the index of the PUCCH-SR resource for BFRQ transmission is associated with an index of the non-failed BFD-RS set.

For example, referring to FIG. 2(a), PUCCH-SR resource 1 is associated with BFD-RS set 1, PUCCH-SR resource 2 is associated with BFD-RS set 2; besides, PUCCH-SR resource 1 is configured to be transmitted to TRP1, and PUCCH-SR resource 2 is configured to be transmitted to TPR2.

Considering a UE staying in PCell0, i.e., the serving cell is PCell0, if the UE detects only beam failure in BFD-RS set 1, it uses PUCCH-SR resource 2 for BFRQ transmission to TRP2 in PCell0; if the UE only detects beam failure in BFD-RS set 2, it uses PUCCH-SR resource 1 for BFRQ transmission to TRP1 in PCell0.

Considering a UE staying in SCell1, SCell2, or SCell3, if the UE detects only beam failure in any BFD-RS set, the UE can select any one of the two PUCCH-SR resources for BFRQ transmission to an associated TRP in PCell0. For example, the serving cell is SCell2, the UE detects beam failure event in BFD-RS set 1, then the UE may use PUCCH-SR resource 1 for BFRQ transmission to TRP1 in PCell0, or the UE may use PUCCH-SR resource 2 for BFRQ transmission to TRP 2 in PCell0, or the UE may use both PUCCH-SR resource 1 and PUCCH-SR resource 2 for BFRQ transmission.

In some embodiments, the UE may even use both the PUCCH-SR resources for BFRQ transmission to both TRPs.

In some embodiments, the index of the PUCCH-SR resource for BFRQ transmission is associated with an index of the failed BFD-RS set.

For example, referring to FIG. 2(a), PUCCH-SR resource 1 is associated with BFD-RS set 1, PUCCH-SR resource 2 is associated with BFD-RS set 2; besides, PUCCH-SR resource 1 is configured to be transmitted to TRP2, and PUCCH-SR resource 2 is configured to be transmitted to TPR1 in PCell0.

Considering a UE staying in PCell0, i.e., the serving cell is PCell0, if the UE detects only beam failure in BFD-RS set 1, it uses PUCCH-SR resource 1 for BFRQ transmission to TRP2; if the UE only detects beam failure event in BFD-RS set 2, it uses PUCCH-SR resource 2 for BFRQ transmission to TRP1 in PCell0.

Considering a UE staying in SCell1, SCell2, or SCell3, if the UE detects only beam failure in any BFD-RS set, the UE can select any one of the two PUCCH-SR resources for BFRQ transmission to an associated TRP in PCell0. For example, the serving cell is SCell2, the UE detects beam failure in BFD-RS set 1, then the UE may use PUCCH-SR resource 2 for BFRQ transmission to TRP1 in PCell0, or the UE may use PUCCH-SR resource 1 for BFRQ transmission to TRP2 in PCell0, or the UE may use both PUCCH-SR resource 1 and PUCCH-SR resource 2 for BFRQ transmission.

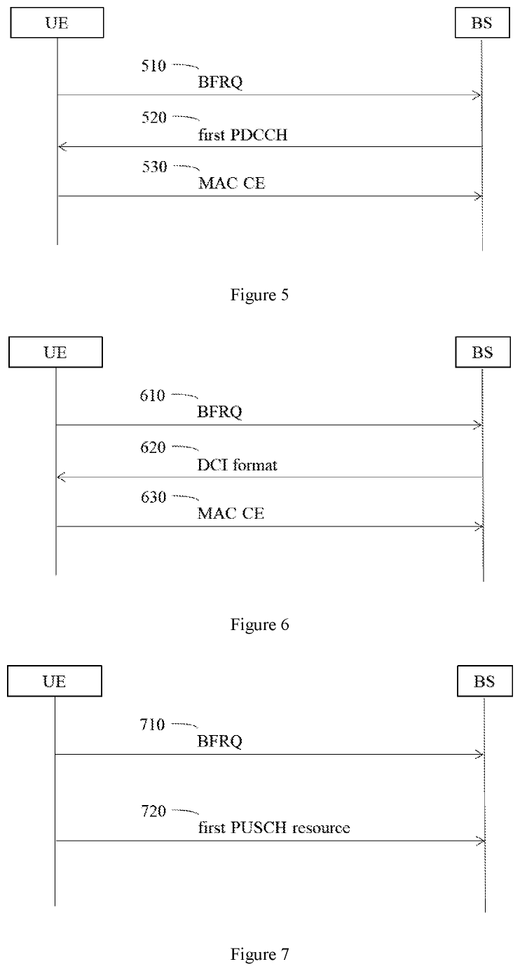

FIG. 5 illustrates an exemplary signaling flow chart once the UE detects that only one BFD-RS set fails and notifies the BS.

As shown in FIG. 5, when the UE detects only one BFD-RS set fails, the UE may transmit BFRQ 510 in a PUCCH-SR resource associated with the non-failed BFD-RS set. In response to the reception of BFRQ 510, the BS may transmit first PDCCH 520 with a DCI format for scheduling a first PUSCH resource. After reception of first PDCCH 520, if the UE finds a new beam in a NBI-RS set associated with the failed BFD-RS set, the UE transmits MAC CE 530 via the first PUSCH resource, wherein MAC CE 530 indicates the index of the failed BFD-RS set and information of the new beam.

According to the present disclosure, if the UE detects both BFD-RS sets fail, the UE may initiate an RA procedure to transmit a BFRQ. The RA procedure may be a CF RA procedure or a CB RA procedure, it depends on the cell configuration (e.g., whether CF-RACH resources are configured for RA) and/or whether a new beam associated with the configured CF-RACH resources is identified. Herein, CF RA means that dedicated RACH resources are configured for random access.

In some embodiments, if one or more CF-RACH resources are configured for the SpCell of the cell group (MCG or SCG), and a new beam associated with a configured CF-RACH resource is found after detection of failures of the two BFD-RS sets, the UE initiates a CF-RA procedure.

FIG. 6 illustrates an exemplary signaling flow chart in the case that the UE detects that both BFD-RS sets fail, wherein one or more CF-RACH resources are configured for the SpCell of the cell group (MCG or SCG).

In the example shown in FIG. 6, the UE detects both BFD-RS set fail. If the UE finds a new beam associated with a configured CF-RACH resource, the UE may initiate a CF-RA procedure and transmit BFRQ 610 according to the new beam associated with a configured CF-RACH resource. In response to the reception of BFRQ 610, the BS may transmit DCI format 620 with CRC scrambled by a C-RNTI or MCS-C-RNTI. After reception of DCI format 620, if the UE finds two new beams found in two NBI-RS sets associated with the two failed BFD-RS sets respectively, the UE transmits MAC CE 630 in a first PUSCH resource, wherein MAC CE 630 indicates the indices of the two failed BFD-RS sets and information of the two new beams found in the two associated NBI-RS sets.

In some embodiments, if one or more CF-RACH resources are configured for the SpCell of the cell group (MCG or SCG), when the UE detects that both two BFD-RS sets fails while no new beam associated with the one or more configured CF-RACH resource is found, the UE may initiate a CB-RA procedure.

In some embodiments, if no CF-RACH resource is configured for the SpCell of the cell group, when the UE detects that both two BFD-RS sets failed, the UE may initiate a CB-RA procedure.

FIG. 7 illustrates an exemplary signaling flow chart in the case that the UE detects that both BFD-RS sets fail and notifies the BS.

In the example shown in FIG. 7, the UE detects both BFD-RS set fail. If one or more CF-RACH resources are configured for a SpCell of a cell group (MCG or SCG), while no new beam associated with a configured CF-RACH resource is found after detection of failure of the two BFD-RS sets, the UE initiates a CB-RA procedure. In addition, if no CF-RACH resource is configured for the SpCell, the UE initiates a CB-RA procedure.

As shown in FIG. 7, the UE initiates a CB-RA procedure and transmit BFRQ 710 during the CB-RA procedure. Furthermore, after the UE finds two new beams in two NBI-RS sets associated with the two failed BFD-RS sets respectively, the UE transmits an MAC CE in first PUSCH resource 720 via Msg 3 in a 4-step CB-RA procedure or via MsgA in a 2-step CB-RA procedure by using the same beam for CB-RACH transmission, wherein the MAC CE indicates the indexes of the two failed BFD-RS sets and information of the two new beams found in the two NBI-RS sets. Herein, Msg 3 is a message transmitted in step 3 of a 4-step RA procedure, and MsgA is a message transmitted in step 1 of a 2-step RA procedure.

It can be seen that, according to the present disclosure, once a UE detects that at least one BFD-RS set fails, the UE may transmit a BFRQ via a PUCCH-SR resource, or transmits a BFRQ according to a beam associated with a configured CF-RACH resource during a CF-RA procedure, or transmits a BFRQ during a CB-RA procedure.

Furthermore, after at least one new beam found in at least one NBI-RS set associated with at least one failed BFD-RS set, the UE transmits an MAC CE indicating the at least one index of the at least one failed BFD-RS set and information about the at least one new beam found in the at least one NBI-RS set.

After reception of the MAC CE, the BS transmits a second PDCCH with a DCI format for scheduling a second PUSCH resource, wherein the DCI format indicates a same HARQ process number as that for transmission of the first PUSCH resource and has a toggled NDI field value. This operation means that the BS confirms that the PUSCH carrying the BFR MAC CE is received by the BS. After the transmission of the confirmation of TRP-specific BFR (i.e., the second PDCCH), the BS updates beams for PDCCH transmission and PUCCH reception.

In some embodiments, after a pre-defined duration since transmission of the confirmation of TRP-specific BFR, the BS updates beams for PDCCH transmission and PUCCH reception.

In some embodiments, the pre-defined duration is 28 symbols from transmission of the last symbol of the second PDCCH.

In some embodiments, the BS transmits PDCCH(s) in all CORESETs associated with at last one failed BFD-RS set by using antenna port quasi co-location parameters corresponding to at least one new beam indicated in the MAC CE, and updates at least one spatial relation and at least one PL-RS for receiving PUCCH resource(s) associated with the at least one failed BFD-RS set according to the at least one new beam indicated in the MAC CE. Herein, a CORESET identifies a set of time-frequency resources for PDCCH transmission and multiple CORESETs can be configured for a serving cell.

After reception of the confirmation of TRP-specific BFR (i.e., the second PDCCH) from the BS, the UE updates beams for PDCCH reception and PUCCH transmission.

In some embodiments, after a pre-defined duration since reception of the confirmation of TRP-specific BFR, the UE updates beams for PDCCH reception and PUCCH transmission.

In some embodiments, the pre-defined duration is 28 symbols from reception of the last symbol of the second PDCCH.

In some embodiments, the UE may monitor PDCCH(s) in all CORESETs associated with at last one failed BFD-RS set by using antenna port quasi co-location parameters corresponding to at least one new beam identified in at least one NBI-RS set associated with at least one failed BFD-RS set, and updating at least one spatial relation and at least one PL-RS for PUCCH resources associated with the at least one failed BFD-RS set according to the at least one new beam identified in the at least one NBI-RS set associated with the at least one failed BFD-RS set.

Here provides an example according to the solution of the present disclosure in a multi-DCI based multi-TRP transmission scenario. The SpCell supports two-TRP transmission, and each CORESET is configured with a RRC parameter CORESETPoolIndex for TRP differential, wherein all CORESETs configured for TRP1 is configured with CORESETPoolIndex 0 and all CORESETs configured for TRP2 is configured with CORESETPoolIndex 1. A UE is configured with two BFD-RS sets (BFD-RS set 1 and BFD-RS set 2) and two NBI-RS sets (NBI-RS set 1 and NBI-RS set 2) on a SpCell while without dedicated CF-RACH resources for BFR. NBI-RS set 1 is associated with BFD-RS set 1, and NBI-RS set 2 is associated with BFD-RS set 2. BFD-RS set 1 is associated with CORESETPoolIndex 0 (i.e., TRP1), and BFD-RS set 2 is associated with CORESETPoolIndex 1 (i.e., TRP2).

When both TRPs are failed, the UE initiates a CB-RA procedure and transmits a BFRQ to a BS during the CB-RA procedure. When the UE identifies a new beam from each NBI-RS sets, the UE transmits an MAC CE via a first PUSCH resource in Msg3 or MsgA, wherein the MAC CE indicates the indices of the two failed BFD-RS sets and information about the two new beams found in NBI-RS set 1 and NBI-RS set 2. Upon reception of the MAC CE, the BS transmits a confirmation of the TRP-specific BER by sending a DCI indicates a same HARQ process number as that for transmission of the PUSCH resource carry the MAC CE and has a toggled NDI field value. After 28 symbols from reception of the last symbol of the confirmation of the TRP-specific BER, the UE monitors PDCCH in all CORESETs associated with CORESETPoolIndex 0 using the same antenna port quasi co-location parameters as the ones associated with the corresponding index q_{new} (i.e., the index of the new beam) identified in NBI-RS set 1 on the SpCell, and monitors PDCCH in all CORESETs associated with CORESETPoolIndex 1 using the same antenna port quasi co-location parameters as the ones associated with the corresponding index q_{new} identified in NBI-RS set 2 on the SpCell; furthermore, the UE updates the spatial relation and the PL-RS of the PUCCH resources associated with CORESETPoolIndex 0 with the q_{new} identified in NBI-RS set 1, and updates the spatial relation and the PL-RS of the PUCCH resources associated with CORESETPoolIndex 1 with the q_{new} identified in NBI-RS set 2.

On the other hand, after 28 symbols from transmission of the last symbol of the confirmation of the TRP-specific BER, the BS transmits PDCCH in all CORESETs associated with CORESETPoolIndex 0 using the same antenna port quasi co-location parameters as the ones associated with the corresponding index q_{new} identified in NBI-RS set 1 on the SpCell, and transmits PDCCH in all CORESETs associated with CORESETPoolIndex 1 using the same antenna port quasi co-location parameters as the ones associated with the corresponding index q_{new} identified in NBI-RS set 2 on the SpCell; furthermore, the BS updates the spatial relation and the PL-RS of the PUCCH resources associated with CORESETPoolIndex 0 with the q_{new} identified in NBI-RS set 1, and updates the spatial relation and the PL-RS of the PUCCH resources associated with CORESETPoolIndex 1 with the q_{new} identified in NBI-RS set 2.

The present disclosure is not limited to the various provided methods and signaling sequences, and these methods and signaling sequences may be reasonably and flexibly adjusted or changed.

According to the present disclosure, various methods and embodiments provide solutions to support TRP specific BFR for a cell group supporting multi-TRP functionality, focusing on when to configure two PUCCH-SR resources for BFRQ transmission, how to select PUCCH-SR resources for BFRQ transmission considering different multi-TRP configuration on different cells, and how to update the beam for PDCCH and PUCCH when both TRPs fail in an SpCell.

Based on the solutions of the present disclosure, two PUCCH-SR resource configurations enhance reliability and robustness of the system performance if only one BFD-RS set fails. Furthermore, even if both the two BFD-RS sets fail, the multi-TRP based radio link can be quickly recovered without MAC CE/RRC re-configuration.

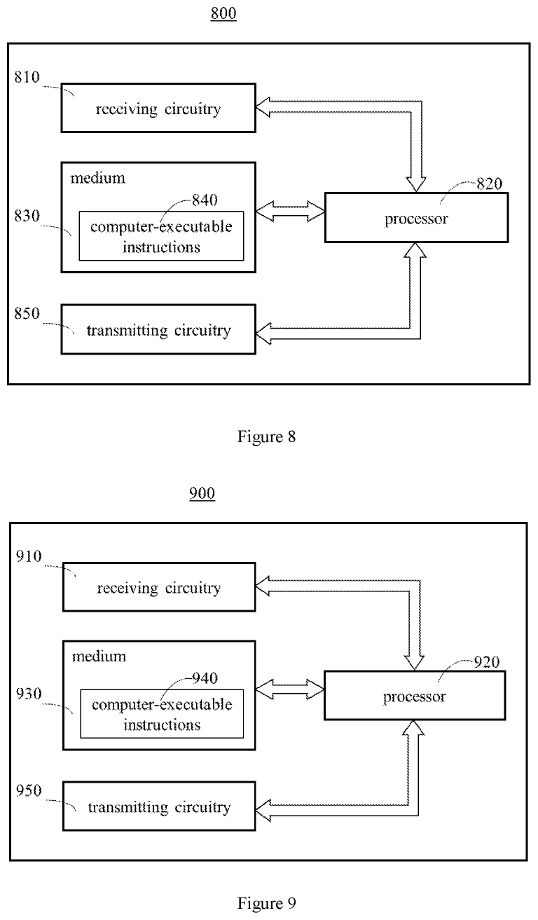

FIG. 8 illustrates a simplified block diagram of an exemplary apparatus 800 according to some embodiments of the present disclosure. The apparatus 800 maybe or include at least a part of a UE or similar device.

As shown in FIG. 8, the apparatus 800 may include at least one receiving circuitry 810, at least one processor 820, at least one non-transitory computer-readable medium 830 with computer-executable instructions 840 stored thereon, and at least one transmitting circuitry 850. The at least one receiving circuitry 810, the at least one non-transitory computer-readable medium 830, and the at least one transmitting circuitry 850 may be coupled to the at least one processor 820. In some embodiments, the at least one receiving circuitry 810, the at least one non-transitory computer-readable medium 830, the at least one transmitting circuitry 850, and the at least one processor 820 may be coupled to each other via one or more local buses.

Although in FIG. 8, elements such as receiving circuitry 810, transmitting circuitry 850, non-transitory computer-readable medium 830, and processor 820 are described in the singular, the plural is contemplated unless limitation to the singular is explicitly stated. In some embodiments of the present disclosure, the at least one receiving circuitry 810 and the at least one transmitting circuitry 850 may be configured for wireless communication. In some embodiments of the present disclosure, the at least one receiving circuitry 810 and the at least one transmitting circuitry 850 can be integrated into at least one transceiver (e.g., wireless transceiver). In certain embodiments of the present disclosure, the apparatus 900 may further include a memory and/or other components.

The computer-executable instructions 840 may be configured to be executable by the at least one processor 820 to cause the apparatus 900 at least to perform, with the at least one receiving circuitry 810, the at least one transmitting circuitry 850, and the at least one processor 820, any one of the various methods described above which are performed by a UE according to the present disclosure. For example, the computer-executable instructions 840, when executed by the at least one processor 820, may cause the apparatus 900 to: receive, with the at least one receiving circuitry 810, configuration information for a first BFD-RS set and a second BFD-RS set for a serving cell; receive, with the at least one receiving circuitry 810, a first MAC CE for activating at least one spatial relation information for a PUCCH resource in the serving cell, wherein the first MAC CE further indicates an association between at least one BFD-RS set of the first BFD-RS set and the second BFD-RS set and the at least one spatial relationship information.

FIG. 9 illustrates a simplified block diagram of an exemplary apparatus 900 according to some embodiments of the present disclosure. The apparatus 900 maybe or include at least a part of a BS or similar device.

As shown in FIG. 9, the apparatus 900 may include at least one receiving circuitry 910, at least one processor 920, at least one non-transitory computer-readable medium 930 with computer-executable instructions 940 stored thereon, and at least one transmitting circuitry 950. The at least one receiving circuitry 910, the at least one non-transitory computer-readable medium 930, and the at least one transmitting circuitry 950 may be coupled to the at least one processor 920. In some embodiments, the at least one receiving circuitry 910, the at least one non-transitory computer-readable medium 930, the at least one transmitting circuitry 950, and the at least one processor 920 may be coupled to each other via one or more local buses.

Although in FIG. 9, elements such as receiving circuitry 910, transmitting circuitry 950, non-transitory computer-readable medium 930, and processor 920 are described in the singular, the plural is contemplated unless limitation to the singular is explicitly stated. In some embodiments of the present disclosure, the at least one receiving circuitry 910 and the at least one transmitting circuitry 950 may be configured for wireless communication. In some embodiments of the present disclosure, the at least one receiving circuitry 910 and the at least one transmitting circuitry 950 can be integrated into at least one transceiver (e.g., wireless transceiver). In certain embodiments of the present disclosure, the apparatus 900 may further include a memory and/or other components.

The computer-executable instructions 940 may be configured to be executable by the at least one processor 920 to cause the apparatus 900 at least to perform, with the at least one receiving circuitry 910, the at least one transmitting circuitry 950, and the at least one processor 920, any one of the various methods described above which are performed by a BS according to the present disclosure. For example, the computer-executable instructions 940, when executed by the at least one processor 920, may cause the apparatus 900 to: transmit, with the at least one transmitting circuitry 950, configuration information for a first BFD-RS set and a second BFD-RS set for a serving cell; transmit, with the at least one transmitting circuitry 950, a first MAC CE for activating at least one spatial relation information for a PUCCH resource in the serving cell, wherein the first MAC CE further indicates an association between at least one BFD-RS set of the first BFD-RS set and the second BFD-RS set and the at least one spatial relationship information.

In various example embodiments, the at least one processor 820 or 920 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the at least one processor 820 or 920 may also include at least one other circuitry or element not shown in FIG. 7 or FIG. 8.

In various example embodiments, the at least one non-transitory computer-readable medium 830 or 930 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the at least non-transitory computer-readable medium 830 or 930 may include, but is not limited to, an electric, a magnetic, an optical, an electromagnetic, an infrared, or a semiconductor system, apparatus, or device or any combination of the above.

Further, in various example embodiments, the example apparatus 900 or 900 may also include at least one other circuitry, element, and interface, for example antenna element, and the like.

In various example embodiments, the circuitries, parts, elements, and interfaces in the example apparatus 900 or 900, including the at least one processor 820 or 900 and the at least one non-transitory computer-readable medium 830 or 930, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A user equipment (UE) for wireless communication, comprising:
at least one memory; and
at least one processor coupled with the at least one memory and configured to cause the UE to:
receive a configuration of two physical uplink control channel scheduling request (PUCCH-SR) resources for beam failure recovery request (BFRQ) transmission for a cell group when two beam failure detection reference signal (BFD-RS) sets and two new beam indication reference signal (NBI-RS) sets are configured for a cell of the cell group, wherein there is one-to-one association between the two PUCCH-SR resources and the two BFD-RS sets, and there is one-to-one association between the two BFD-RS sets and the two NBI-RS sets; and
transmit, in response to one of the two BFD-RS sets is failed, a BFRQ in one PUCCH-SR resource of the two PUCCH-SR resources according to an association between the two PUCCH-SR resources and the two BFD-RS sets.

17. The UE of claim 16, wherein an index of the one PUCCH-SR resource is associated with an index of one of the two BFD-RS sets which is not failed.

18. The UE of claim 16, wherein an index of the one PUCCH-SR resource is associated with an index of one of the two BFD-RS sets which is failed.

19. The UE of claim 16, wherein in response to that only one BFD-RS set of the two BFD-RS sets is failed, the at least one processor is configured to cause the UE to:
receive a first physical downlink control channel (PDCCH) with a downlink control information (DCI) format for scheduling a first physical uplink shared channel (PUSCH) resource; and
transmit a medium access control (MAC) control element (CE) in the first PUSCH resource to indicate an index of the failed BFD-RS set and information of a new beam found in a NBI-RS set associated with the failed BFD-RS set.

20. The UE of claim 16, wherein in response to that the two BFD-RS sets are both failed, a random access (RA) procedure is performed, and the RA procedure is a contention-free random access procedure when one or more CF-RACH resources are configured for the cell and a new beam associated with one CF-RACH resource is found.

21. The UE of claim 20, wherein in response to that the new beam is found, the at least one processor is configured to cause the UE to:
detect a DCI format with cyclic redundancy check (CRC) scrambled by cell-radio network temporary identifier (C-RNTI) or modulation coding scheme C-RNTI (MCS-C-RNTI) in a dedicated search space for BFR procedure; and
transmit a MAC CE in a first PUSCH resource scheduled by the DCI format to indicate indices of the two failed BFD-RS sets and information of new beams identified in the two NBI-RS sets associated with the failed BFD-RS sets.

22. The UE of claim 16, wherein in response to that the two BFD-RS sets are both failed, a random access (RA) procedure is performed, and the RA procedure is a contention-based RACH (CB-RACH) procedure when no CF-RACH resource is configured or one or more CF-RACH resources are configured while no new beam associated with the CF-RACH resources is found.

23. The UE of claim 22, wherein in response to that two new beams are found in the two NBI-RS sets associated with the two failed BFD-RS sets, the at least one processor is configured to cause the UE to:
transmit a MAC CE in a first PUSCH resource via Msg3 or MsgA to indicate the indices of the two failed BFD-RS sets and information of the two new beams identified in the two NBI-RS sets.

24. The UE of claim 23, wherein the at least one processor is configured to cause the UE to receive a second PDCCH with a DCI format for scheduling a second PUSCH resource, wherein the DCI format indicates a same hybrid automatic repeat request (HARQ) process number as that for transmission of the first PUSCH resource and has a toggled new data indication (NDI) field value.

25. The UE of claim 24, wherein after a pre-defined number of symbols from reception of a last symbol of the second PDCCH, the at least one processor is configured to cause the UE to:
monitor one or more PDCCH in control resource sets (CORESETs) associated with at last one failed BFD-RS set by using antenna port quasi co-location parameters corresponding to at least one new beam identified in at least one NBI-RS set associated with at least one failed BFD-RS set; and
update at least one spatial relation and at least one PL-RS for PUCCH resources associated with the at least one failed BFD-RS set according to the at least one new beam identified in the at least one NBI-RS set associated with the at least one failed BFD-RS set.

26. A processor for wireless communication, comprising:
at least one controller coupled with at least one memory and configured to cause the processor to:
receive a configuration of two physical uplink control channel scheduling request (PUCCH-SR) resources for beam failure recovery request (BFRQ) transmission for a cell group when two beam failure detection reference signal (BFD-RS) sets and two new beam indication reference signal (NBI-RS) sets are configured for a cell of the cell group, wherein there is one-to-one association between the two PUCCH-SR resources and the two BFD-RS sets, and there is one-to-one association between the two BFD-RS sets and the two NBI-RS sets; and
transmit, in response to one of the two BFD-RS sets is failed, a BFRQ in one PUCCH-SR resource of the two PUCCH-SR resources according to an association between the two PUCCH-SR resources and the two BFD-RS sets.

27. The processor of claim 26, wherein an index of the one PUCCH-SR resource is associated with an index of one of the two BFD-RS sets which is not failed.

28. The processor of claim 26, wherein an index of the one PUCCH-SR resource is associated with an index of one of the two BFD-RS sets which is failed.

29. The processor of claim 26, wherein in response to that only one BFD-RS set of the two BFD-RS sets is failed, the at least one controller is configured to cause the processor to:
receive a first physical downlink control channel (PDCCH) with a downlink control information (DCI) format for scheduling a first physical uplink shared channel (PUSCH) resource; and
transmit a medium access control (MAC) control element (CE) in the first PUSCH resource to indicate an index of the failed BFD-RS set and information of a new beam found in a NBI-RS set associated with the failed BFD-RS set.

30. The processor of claim 26, wherein in response to that the two BFD-RS sets are both failed, the RA procedure is a contention-free random access procedure when one or more CF-RACH resources are configured for the cell and a new beam associated with one CF-RACH resource is found, and wherein in response to that the new beam is found, the at least one controller is configured to cause the processor to:
detect a DCI format with cyclic redundancy check (CRC) scrambled by cell-radio network temporary identifier (C-RNTI) or modulation coding scheme C-RNTI (MCS-C-RNTI) in a dedicated search space for BFR procedure; and
transmit a MAC CE in a first PUSCH resource scheduled by the DCI format to indicate indices of the two failed BFD-RS sets and information of new beams identified in the two NBI-RS sets associated with the failed BFD-RS sets.

31. The processor of claim 26, wherein in response to that the two BFD-RS sets are both failed, a random access (RA) procedure is performed, and the RA procedure is a contention-based RACH (CB-RACH) procedure when no CF-RACH resource is configured or one or more CF-RACH resources are configured while no new beam associated with the CF-RACH resources is found.

32. The processor of claim 31, wherein in response to that two new beams are found in the two NBI-RS sets associated with the two failed BFD-RS sets, the at least one controller is configured to cause the processor to:
transmit a MAC CE in a first PUSCH resource via Msg3 or MsgA to indicate the indices of the two failed BFD-RS sets and information of the two new beams identified in the two NBI-RS sets.

33. The processor of claim 32, wherein the at least one controller is configured to cause the processor to receive a second PDCCH with a DCI format for scheduling a second PUSCH resource, wherein the DCI format indicates a same hybrid automatic repeat request (HARQ) process number as that for transmission of the first PUSCH resource and has a toggled new data indication (NDI) field value.

34. The processor of claim 33, wherein after a pre-defined number of symbols from reception of a last symbol of the second PDCCH, the at least one controller is configured to cause the processor to:
monitor one or more PDCCH in control resource sets (CORESETs) associated with at last one failed BFD-RS set by using antenna port quasi co-location parameters corresponding to at least one new beam identified in at least one NBI-RS set associated with at least one failed BFD-RS set; and
update at least one spatial relation and at least one PL-RS for PUCCH resources associated with the at least one failed BFD-RS set according to the at least one new beam identified in the at least one NBI-RS set associated with the at least one failed BFD-RS set.

35. A method performed by a user equipment (UE), the method comprising:
receiving a configuration of two physical uplink control channel scheduling request (PUCCH-SR) resources for beam failure recovery request (BFRQ) transmission for a cell group when two beam failure detection reference signal (BFD-RS) sets and two new beam indication reference signal (NBI-RS) sets are configured for a cell of the cell group, wherein there is one-to-one association between the two PUCCH-SR resources and the two BFD-RS sets, and there is one-to-one association between the two BFD-RS sets and the two NBI-RS sets; and
transmitting, in response to one of the two BFD-RS sets is failed, a BFRQ in one PUCCH-SR resource of the two PUCCH-SR resources according to an association between the two PUCCH-SR resources and the two BFD-RS sets.
